(19) United States
(12) Patent Application Publication
(10) Pub. No.: US 2002/0141027 A1
(43) Pub. Date: Oct. 3, 2002

(54) Variable pulse width optical pulse generation with superposed multiple frequency drive

(76) Inventors: Michael J. LaGasse, Lexington, MA (US); Simon Verghese, Arlington, MA (US); Sean Duffy, West Newton, MA (US)

Correspondence Address: Elizabeth E. Kim, McDermott Will & Emery, 28 State Street, Boston, MA, 02109, US

(21) Appl. No.: 09/973,873

(22) Filed: Oct. 10, 2001

Related U.S. Application Data
(60) Provisional application No. 60/270,016, filed on Feb. 20, 2001.

(51) Int. Cl. G02F 1/00

(52) U.S. Cl. 359/237

(57) ABSTRACT

A variable pulse width optical pulse generation system includes a first and a second optical interferometric modulator. A first drive signal applied to the first modulator modulates an input optical signal, so as to provide a first modulated optical signal. A second drive signal applied to the second modulator modulates the first modulated optical signal, producing output optical pulses. One or both of the drive signals may be formed by superposing a plurality of waveforms having different frequencies, for example a base frequency and its odd harmonics. By adjusting the relative amplitudes of the drive signals, or the relative amplitudes of the component waveforms forming the drive signals, the pulse width and the extinction ratio of the output pulses can be varied so as to achieve an optimal value.

### CROSS-REFERENCE TO RELATED APPLICATIONS

This application claims right of priority based on U.S. Provisional Application Serial No. 60/270,016, filed on Feb. 20, 2001.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention relates to optical pulse generation, and in particular, to the generation of tunable pulse width optical pulses.

### BACKGROUND OF THE INVENTION

The explosive growth in telecommunications and computer networking has led to an acute need for very high-bandwidth transmission systems. One approach to ultra-fast transmission is time-division-multiplexing (TDM) in all-optical networks, i.e. optical time-division-multiplexed (OTDM) networks. Implementing the functional units constituting an OTDM network requires special considerations, because an OTDM network must have the capability of handling ultra-fast optical signals. In particular, very narrow optical pulses, with high repetition rates, must be generated, and these narrow optical pulses must be multiplexed and de-multiplexed. Narrow optical pulses are pulses that occupy very small intervals of time, or optical pulses that have a steep intensity change produced by a control signal.

An optical pulse must be very narrow for high-speed OTDM transmission, because a single clock pulse is split into multiple channels, depending on the ratio by which the data transmission rate of a single channel is to be enhanced through optical multiplexing. The optical pulses in all of the channels are optically modulated, in parallel. The optical pulse outputs from the multiple channels are then combined together, resulting in an optically multiplexed OTDM signal. The original clock pulses must thus be narrow enough so as to avoid overlapping within a single channel. In particular, for high bandwidth optical communications networks it is desirable that optical pulses be narrow enough to fit into a single channel having a bandwidth of at least 40 Gb/sec or higher.

At high data rates, it is difficult to generate narrow optical pulses with prior art pulse generators, especially for very long distance propagation. Prior art approaches to generating optical pulses include the use of gain-switched semiconductor lasers, and the use of mode-locked lasers. There also exist several prior art pulse generators for generating narrow pulses that include cascaded replications of Mach-Zehnder interferometers. In these prior art devices, the input signals and operating bias state of the aggregate device are controlled in a variety of ways, depending on the design. In one prior art design, disclosed in U.S. Pat. No. 4,505,587 issued to H. A. Haus et al. (the “'587 patent”), a set of cascaded Mach-Zehnder interferometers are used to generate fast optical pulses. In the '587 patent, input signals having the same bias voltages but successively increasing frequencies are applied to each of a series of cascaded interferometers. Other prior art designs partially modulate the transfer function of a modulator with a device, such as an electro-absorption modulator, in order to generate fast pulses.

These prior art methods suffer from a number of disadvantages. For example, a plurality of components must be used, one for each drive frequency, adding to the physical size requirements for the device. Also, it is difficult to control the optical pulse characteristics, such as pulse width, spectrum, and extinction ratio, over a desired range of operating conditions, when these prior art methods are used.

U.S. patent application Ser. No. 09/916,861 (hereinafter the “'861 application”), entitled “Optical Pulse Generator With Single Frequency Drive,” which is commonly owned by the present assignee and which is incorporated herein by reference, discloses an optical pulse generation system that overcomes some of these disadvantages. In the '861 application, optical pulses characterized by a relatively narrow pulse width, as well as a relatively high extinction ratio, are generated by driving a pair of cascaded interferometric modulators at substantially the same drive frequency, and by selecting substantially different bias voltages and drive amplitudes for each modulator. Because both modulators are driven at the same frequency, narrow optical pulses (about 16 ps) are generated at a high repetition rate (about 10 Gb/sec), using a relatively small number of commercially available parts. Using a single frequency drive, and substantially different bias conditions for the first and second drive signals, the extinction ratio of the optical pulses can be increased to about 25 dB, by choosing bias voltages and drive amplitudes that optimize the extinction ratio. In other words, the amplitudes of the side lobes of optical power can be reduced to a magnitude that is about 25 dB lower, as compared to the amplitudes of the main output pulses, in the system featured in the '861 application.

It is desirable, however, to further suppress the side lobe energy of the optical pulses, because the residual amount of side lobe energy causes coherent interference when the output optical pulses are optically time-division multiplexed. Such coherent interference reduces the link margin. It is therefore desirable to reduce coherent interference by maximizing the extinction ratio of the output optical pulses. Maximizing the extinction ratio is critical for reducing crosstalk in OTDM networks.

It is desirable to provide a system and method for generating, with relative ease of implementation, very narrow optical pulses that have a highly suppressed side lobe energy, permitting significant reduction of coherent interference during optical time-division multiplexing. It is also desirable to provide an optical pulse generation system and method which enable robust control of the pulse characteristics such as pulse width, frequency, and extinction ratio, over a wide range of operating conditions.

### SUMMARY OF THE INVENTION

The present invention relates to a tunable pulse width optical pulse generation system and method. Narrow optical pulses with a high extinction ratio are generated by driving cascaded interferometric modulators with drive signals whose drive amplitudes are adjusted until a desired pulse width is obtained. In a preferred embodiment, at least one of the drive signals comprises multi-frequency waveforms.

A principal discovery of the present invention is that the pulse width and the extinction ratio of output optical pulses can be controlled by varying the relative drive levels of drive signals that are used to drive a system of cascaded interferometric modulators. Another principal discovery of the present invention is that the fluctuations caused by coherent interference during optical time-division multiplexing of the output optical pulses from such cascaded modulator systems may be significantly reduced, by applying drive signals that are characterized by a multi-frequency waveform. Another principal discovery of the present invention is that the pulse width and the extinction ratio of the output optical pulses generated by a system of cascaded interferometric modulators can be controlled, by varying the relative amplitudes of the individual frequency components constituting the drive signals used to drive each interferometric modulator.

The present invention features an optical pulse generator including a first optical interferometric modulator, and a second optical interferometric modulator. The first modulator has an optical input for receiving an input optical signal, and at least one modulation input for receiving a first modulation drive signal centered about a first normalized bias voltage V1. The first modulation drive signal modulates the input optical signal about the first normalized bias voltage with a first normalized amplitude A1. The first modulator has an optical output for providing a first modulated optical signal, which is received into the optical input of the second modulator.

The second modulator includes an optical input for receiving the first modulated optical signal, and at least one modulation input for receiving a second modulation drive signal centered about a second normalized bias voltage V2. The second modulation drive signal modulates the first modulated optical signal about the second normalized bias voltage with a second normalized amplitude A2. The second modulator has an optical output for providing a second modulated optical signal that comprises output optical pulses.

The relative drive levels of the first and the second modulation drive signals, i.e. the ratio between A1 and A2, are varied, until a desired pulse width and/or a desired extinction ratio is achieved for the output optical pulses generated by the system.

In a preferred embodiment of the invention, at least one of the first and second modulation drive signals is a superposed multi-frequency signal, which includes a combination of a plurality of waveforms having different frequencies. Preferably, the combined signal includes a base waveform characterized by i) a base frequency coo, and ii) one or more odd harmonics of the base waveform, having frequencies Con that related to said base frequency ω₀ according to the formula:

ωₙ=(2n+1)*ω₀

where n is a nonzero integer.

In one embodiment of the invention, the relative amplitudes of the individual waveforms constituting the superposed multi-frequency signal are varied, until the output optical pulses generated by the system have a predetermined extinction ratio, and/or a predetermined pulse width. In one embodiment of the invention, the predetermined extinction ratio is between about 40 dB to about 50 dB. In this way, fluctuations caused by coherent interference is reduced to less than about 0.2 dB. In one embodiment, the predetermined pulse width is about 9 ps to about 16 ps.

The present invention features a method of generating optical pulses. The method includes generating a first modulated optical signal by applying a first modulation drive signal to a first optical interferometric modulator, so as to modulate an input optical signal (for example provided by a CW laser source) received into the modulator. The method includes generating a second modulated optical signal, in the form of narrow optical pulses, by applying a second modulation voltage drive signal to a second optical interferometric modulator so as to modulate the first modulated optical signal.

The method includes varying the relative amplitudes of the first and second drive signals, so as to achieve output optical pulses having a desired pulse width, and a desired extinction ratio. In a preferred embodiment of the invention, the first and the second drive signals are biased at a maximum optical transmission.

In a preferred embodiment of the invention, one or both of the first and second drive signals are formed by superposing a plurality of waveforms having different frequencies. In one embodiment, a base waveform having a base frequency may be superposed with its odd harmonics so as to form a superposed multi-frequency drive signal. The method includes varying the relative amplitudes of the frequency components of the superposed multi-frequency drive signal, so as to substantially maximize the extinction ratio and substantially minimize the pulse width of the output optical pulses.

### BRIEF DESCRIPTION OF THE DRAWINGS

The invention can be more fully understood by referring to the following detailed description taken in conjunction with the accompanying drawings, in which:

FIG. 1A illustrates a variable pulse width optical pulse generation system constructed in accordance with one embodiment of the present invention, including a first optical interferometric modulator driven with a single frequency drive signal, and a second optical interferometric modulator driven with a superposed multi-frequency drive signal.

FIG. 1B illustrates a Mach-Zehnder interferometric modulator, as known in the prior art.

FIG. 2A illustrates the modulator transfer function for the first optical interferometric modulator for the system illustrated in FIG. 1A.

FIG. 2B illustrates the modulator transfer function for the second optical interferometric modulator for the system illustrated in FIG. 1A.

FIG. 2C illustrates the RF drive signals for the first and the second modulator in the system illustrated in FIG. 1A.

FIG. 2D illustrates the pulse carving functions from the first and the second modulators, for the system illustrated in FIG. 1A, as well as the output optical pulses generated by the system.

FIG. 2E illustrates the pulse shape of the output optical pulses from the optical pulse generation system shown in FIG. 1A.

FIG. 2F illustrates the fluctuations due to OTDM coherent interference, for the output optical pulses generated by the system illustrated in FIG. 1A.

FIG. 3 illustrates a cascaded interferometric modulator system in which both modulators are driven with single frequency drive signal biased at a maximum optical transmission, and characterized by identical drive amplitudes.

FIG. 4A illustrates the modulator transfer function for the first and second interferometric modulators for the system illustrated in FIG. 3, as well as the RF drive signal applied to the first and the second modulator.

FIG. 4B illustrates the pulse carving functions from the first and the second modulators, for the system illustrated in FIG. 3.

FIG. 4C illustrates the pulse shape of the output optical pulses from the optical pulse generation system shown in FIG. 3.

FIG. 4D illustrates the fluctuations due to OTDM coherent interference, for the optical pulses generated in FIG. 3.

FIG. 5 illustrates a cascaded interferometric modulator system in which both modulators are driven with single frequency drive signals biased at a maximum optical transmission, and characterized by substantially different drive amplitudes.

FIG. 6A illustrates the modulator transfer function, and the RF drive signals, for the first and the second modulator shown in FIG. 5.

FIG. 6B illustrates the pulse carving functions for the pulse generation system illustrated in FIG. 5, as well as the optical output pulses generated by the system.

FIG. 6C illustrates the pulse shape for the output optical pulses from the optical pulse generation system shown in FIG. 5.

FIG. 6D illustrates the fluctuations due to OTDM coherent interference, for the optical pulses generated in FIG. 5.

FIG. 7 illustrates a variable pulse width optical pulse generation system with a superposed multi-frequency drive, in which the relative amplitudes of the frequency components are chosen so as to minimize the pulse width of the output optical pulses.

FIG. 8A illustrates the modulator transfer function for the first and second interferometric modulators for the system illustrated in FIG. 7.

FIG. 8B illustrates the RF drive signals for the first and the second modulator in the system illustrated in FIG. 7.

FIG. 8C illustrates the pulse carving functions for the first and the second modulators shown in FIG. 7.

FIG. 8D illustrates the pulse shape of the output optical pulses from the optical pulse generation system shown in FIG. 7.

FIG. 8E illustrates the fluctuations due to OTDM coherent interference, for the optical pulses generated by the optical pulse generation system shown in FIG. 7.

FIG. 9 illustrates a variable pulse width optical pulse generation system having a superposed multi-frequency drive, in which the relative amplitudes of the frequency components are chosen so as to minimize coherent interference during optical time division multiplexing.

FIG. 10A illustrates the modulator transfer function for the first and second interferometric modulators for the system illustrated in FIG. 9.

FIG. 10B illustrates the RF drive signals for the first and the second modulator in the system illustrated in FIG. 9.

FIG. 10C illustrates the pulse carving functions for the first and the second modulators shown in FIG. 9.

FIG. 10D illustrates the pulse shape of the output optical pulses from the optical pulse generation system shown in FIG. 9.

FIG. 10E illustrates the fluctuations due to OTDM coherent interference, for the optical pulses generated by the optical pulse generation system shown in FIG. 9.

### DETAILED DESCRIPTION

The present invention is directed to a system and method for generating narrow RZ (return-to-zero) optical pulses with a tunable pulse width and extinction ratio. A pair of cascaded modulators are driven with electric drive signals, so as to generate narrow optical pulses having a highly reduced side lobe energy. The relative drive levels of the drive signals are varied, until a desired pulse width and/or a desired extinction ratio is reached for the output optical pulses. In a preferred embodiment of the invention, at least one of the drive signals is formed by combining multiple frequencies.

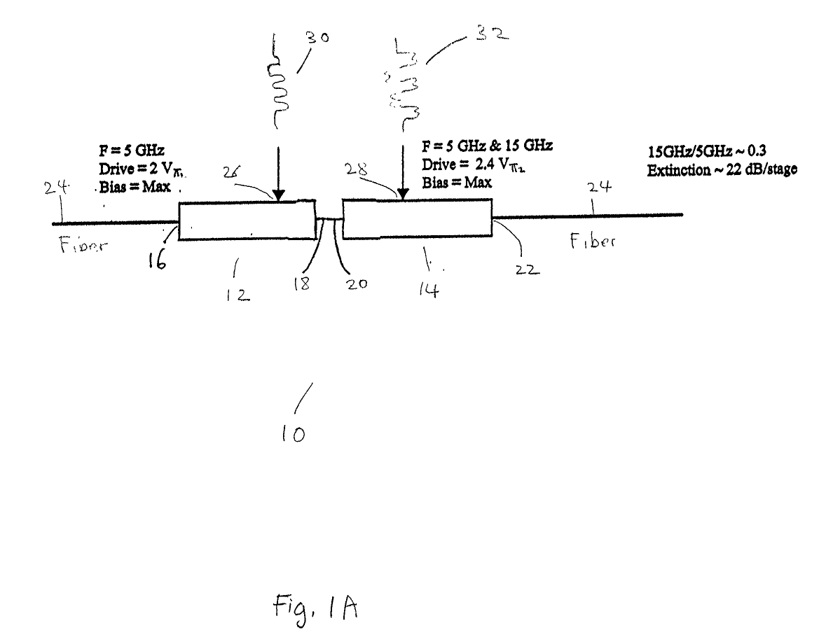

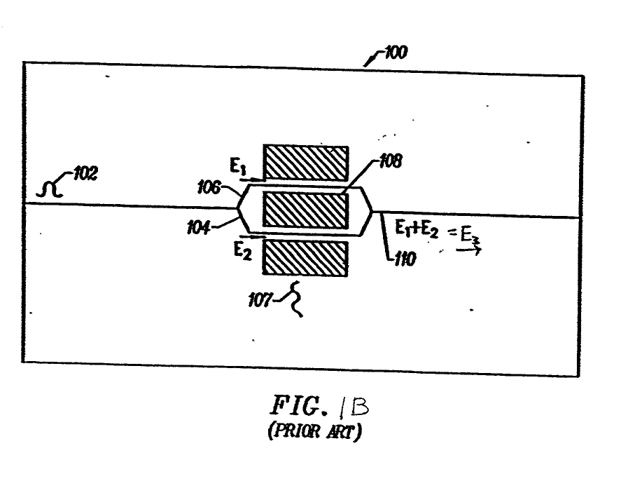

FIG. 1A illustrates a variable pulse width optical pulse generation system 10, constructed in accordance with one embodiment of the present invention. The system 10 includes a first optical interferometric modulator 12, and a second optical interferometric modulator 14. The first modulator 12 includes an optical input 16 for receiving an optical input signal, a modulation input 26 for receiving a modulation drive signal, and an optical output 20 for providing a first modulated optical signal. The second modulator 14 includes an optical input 18 for receiving the first modulated optical signal, a modulation input 28 for receiving a modulation drive signal, and an optical output 22 for providing a second modulated optical signal. The optical output 20 of the first interferometric modulator 12 is coupled to the optical input 18 of the second interferometric modulator 14.

In a preferred embodiment, the first 12 and second 14 optical interferometric modulators are Mach-Zehnder interferometric modulators. FIG. 1B illustrates a Mach-Zehnder interferometric modulator, as known in the prior art. In a Mach-Zehnder interferometer, an incoming optical signal 102 is split at a Y-junction into two signals, E₁ and E₂. Each signal enters a first waveguide branch 104 and a second waveguide branch 106, respectively. The signals are recombined into an output waveguide 110, which provides a modulated optical output signal, E₃.

Preferably, the Mach-Zehnder modulator 100 is formed on a lithium niobate substrate. Because of its high electro-optic coefficient, lithium niobate provides an efficient means of achieving optical modulation. Because lithium niobate is optically active, the index of refraction of a waveguide region can be altered by applying an electric field in that region. Typically, a modulation signal 107 is applied to a modulator input electrode 108. The signal 107 causes an electric field to be applied to one or both of the waveguide branches 104 and 106.

In accordance with the electro-optic effect, an electric field applied to a waveguide branch causes the index of refraction in the waveguide branch to change with the changing amplitude of the modulating signal. The change in the index of refraction alters the speed (or phase) of light in the region, resulting in a change in the delay time of the light passing through the region. The modulation signal thus enables the optical path length in one or both of the waveguide branches to be controlled, and a phase difference results between the two signals E₁ and E₂, when they are recombined at the output waveguide 110. The interference of the two recombined signals results in an intensity modulated output signal E3.

Referring back to FIG. 1A, the first interferometric modulator 12 is driven with a first modulation drive signal 30 which is applied to the modulation input 26. The second modulator is driven with a second modulation drive signal 32 which is applied to the modulation input 28. In the embodiment illustrated in FIG. 1A, the first modulation drive signal 30 is a single frequency signal, having a frequency of about 5 GHz, whereas the second modulation voltage drive signal 32 is a superposed multi-frequency signal that includes a combination of different frequencies.

In a preferred form, the present invention features combining i) a base waveform characterized by a base frequency (ω₀, and ii) one or more odd harmonics of the base waveform, the odd harmonics having frequencies ωₙ that related to said base frequency coo according to the formula:

ωₙ=(2n+1)*ω₀

where n is a nonzero integer. In the embodiment illustrated in FIG. 1A, ω₀=5 GHz, and n=1, so that the second modulation voltage drive signal 32 is a superposition of a 5 GHz signal and a 15 GHz signal.

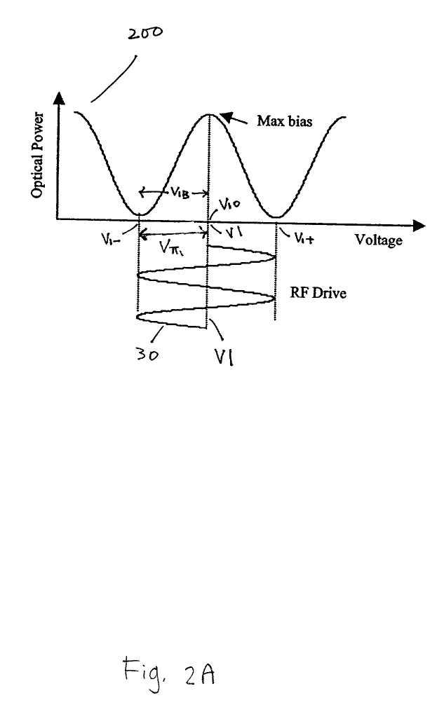

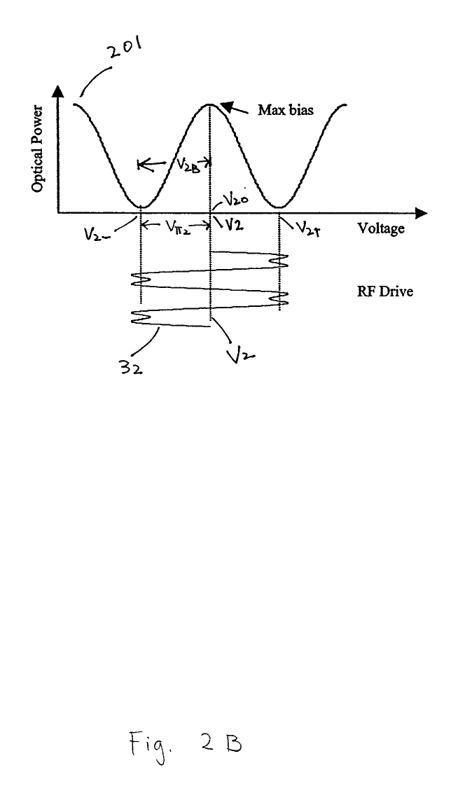

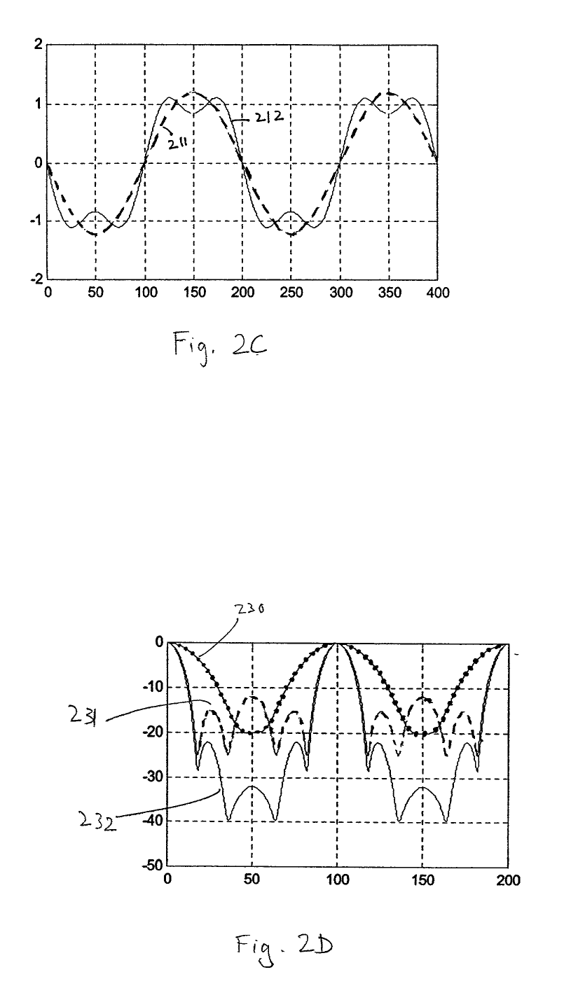

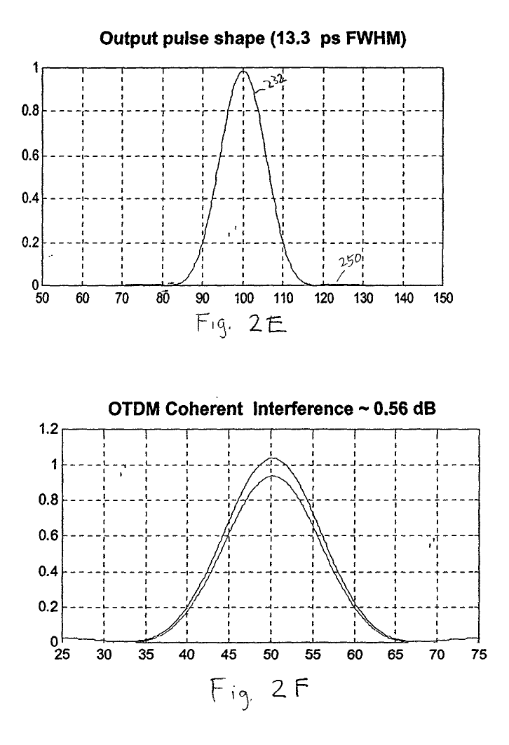

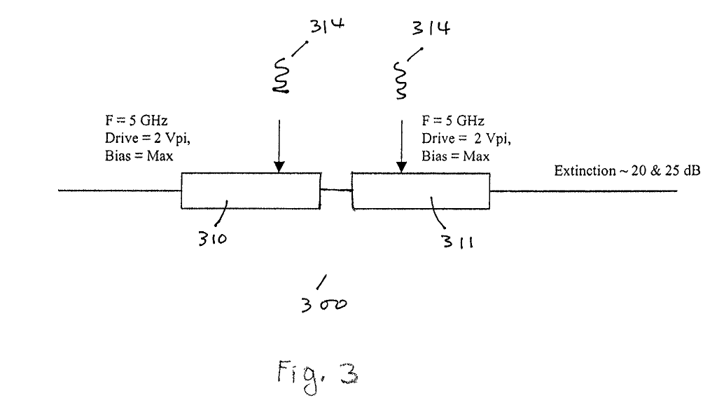

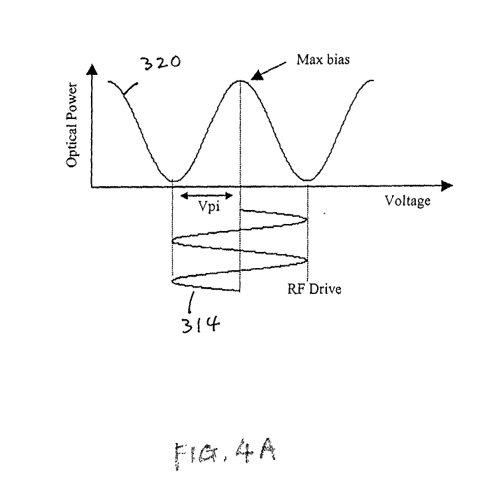

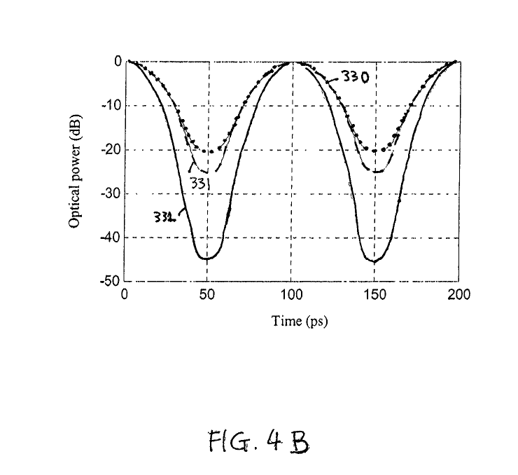

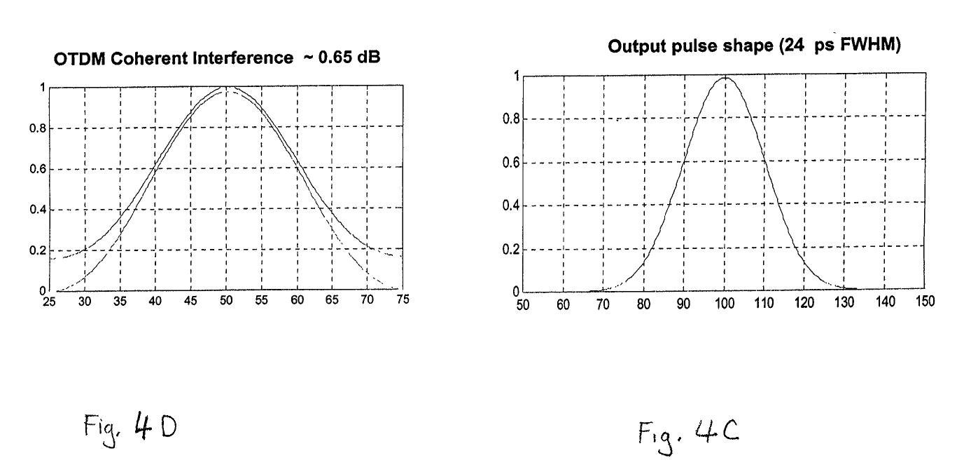

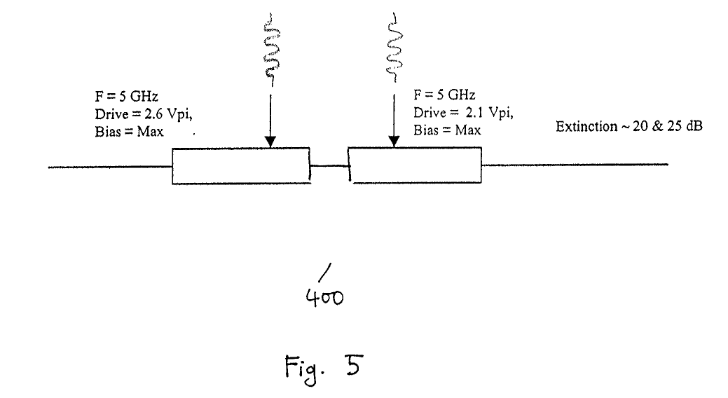

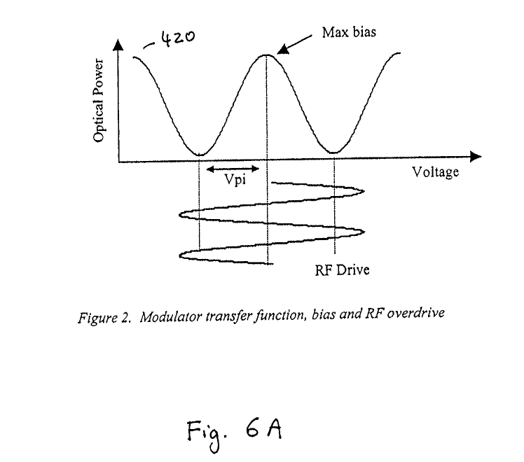

FIG. 2A illustrates the modulator transfer function 200 for the first interferometric modulator 12 for the system 10 illustrated in FIG. 1A. The modulation transfer function 200 defines the optical output power from the modulator 12 as a function of the applied modulation voltage, and is characterized by a parameter Vπ₁, which represents the voltage required to change the optical output power from the first modulator 12 from a minimum value to a maximum value. As seen from FIG. 2A, the modulator transfer function 200 is a periodic function of drive voltage. The transfer function 200 preferably has a “raised cosine” sinusoidal form, i.e. the modulation transfer function may be expressed as a function of drive voltage V as:

I=Imaxcos²(π*V/(2V_{π}))

where Imax is the magnitude of the maximum optical output power, although other periodic forms of the transfer function 200 are also within the scope of the present invention. In the illustrated embodiment, the modulator transfer function 200 is symmetrical about a center voltage V₁₀ between a lower drive voltage V₁₋ and an upper drive voltage V₁₊, and is substantially a single period sinusoid, as a function of drive voltage, between V₁₋ and V₁₊. The modulator transfer function 200 has a maximum value at V₁₀, and a minimum value at V₁₋ and at V₁₊.

The first drive signal 30 is biased at the transfer function maximum, i.e. centered about a first bias voltage chosen to correspond to the modulation drive voltage at which the output optical power from the first interferometric modulator 12 has a peak value. The first bias voltage V1 may be expressed as V1=V₁₋+V_{1B}, where V_{1B} is a voltage magnitude normalized to Vπ₁. In the embodiment illustrated in FIG. 2A, V_{1B} is equal to Vπ₁ The first bias voltage V1 biases the first modulator 12 at the maximum optical transmission, so that V1 happens to be equal to V₁₀. As indicated in FIG. 2A, the corresponding RF drive amplitude for the first modulator is substantially twice Vπ₁.

FIG. 2B illustrates the modulator transfer function 201 for the second interferometric modulator 14. The second interferometric modulator 14 and its transfer function are characterized by a parameter Vπ₂, representing the voltage required to change the optical output power from the second modulator 14 from a minimum value to a maximum value. Preferably, the modulator transfer function 201 is substantially identical to the modulator transfer function 200 (shown in FIG. 2A). In the illustrated embodiment, the modulator transfer function 201 is also symmetrical about a center voltage V₂₀ between a lower drive voltage V₂₋ and an upper drive voltage V₂₊, and is substantially a single period sinusoid, as a function of drive voltage, between V₂₋ and V₂₊. The modulator transfer function 201 has a maximum value at V₂₀, and a minimum value at V₂₋ and at V₂₊.

The second modulator is driven with a drive signal 32 formed by superposing a 5 GHz sinusoidal waveform with a 15 GHz sinusoidal waveform, as described earlier. In the illustrated embodiment, the relative amplitude of the 15 GHz signal, as compared to the amplitude of the 5 GHz signal, is chosen to be 0.3. The modulation drive signal 32 is centered about a second bias voltage V2, which can be expressed as: V2=V₂₋+V_{2B}, where V_{2B} is a voltage magnitude normalized to Vπ₂. In the embodiment illustrated in FIG. 2B, the second bias voltage V2 biases the second modulator at the maximum optical transmission, so that V2 happens to be equal to V₂₀, and V_{2B} happens to be equal to Vπ₂ . As indicated in FIG. 2B, the RF drive amplitude for the 5 GHz frequency component of the drive signal 32 for the second modulator is chosen to be about (2.4)*Vπ₂. The drive amplitude for the 15 GHz component of the drive signal 32 is thus about (0.3)*(2.4)*Vπ₂. Accordingly, the illustrated embodiment represents an “overdrive” case, in which the peak-to-peak amplitude of the modulation drive signal is greater that twice the modulator Vπ.

The RF drive signal for the second modulator, as well as the 5 GHz frequency component of the drive signal, are illustrated in FIG. 2C. The solid curve 212 illustrates the combined multi-frequency drive signal applied to the modulation input 28 of the second modulator 14. The multi-frequency drive signal 212 includes a 5 GHz component, and a 15 GHz component. The dashed curve 211 illustrates the 5 GHz single frequency component of the drive signal 212. It can be seen that as n increases, i.e. as more and more odd harmonics are added onto the base waveform, the resulting combined RF drive signal approaches a square wave.

FIG. 2D illustrates the pulse carving functions for the first and the second modulators, together with the optical output pulses generated by the system illustrated in FIG. 1A. The dotted curve 230 illustrates the first stage pulse carving curve, i.e. represents a first modulated optical signal 230 generated from the output 20 of the first modulator 12. The dashed curve 231 illustrates the second stage pulse carving curve, i.e. represents the signal that would nominally result, assuming a constant input optical power at the optical input 16, when the second modulator is driven with the second modulation drive signal 32 biased at the maximum optical transmission. Since the optical signal received at the input of the second modulator is in fact not constant, but rather has the time varying modulated output of the first interferometric modulator, the second stage further modifies the pulses resulting from the first stage, to provide at the optical output 22 of the system 10 a set of output optical pulses illustrated by the solid curve 232.

FIG. 2E illustrates the pulse shape of the output optical pulses 232 that result from the optical pulse generation system 10 shown in FIG. 1A. The output optical pulses are characterized by a pulse width of about 13.3 ps. A small amount of residual side lobe power 250 is visible.

The residual side lobe energy causes coherent interference, when the pulses are optical time-division multiplexed. It is desirable to minimize leakage power, because such coherent interference reduces the link margin. In addition to leakage caused by the side lobes, there may be additional leakage due to imperfect extinction in the lithium niobate interferometric modulator. A seemingly negligible amount of side lobe energy can result, after optical multiplexing, in substantial fluctuations in optical power. In general, the extinction ratio (ER) of an optical pulse is given by:

ER=10log(P_{H}/P_{L})

where P_{H} and P_{L} are high level and low level output optical power of the optical pulses. Side lobe energy of the order of only 1-2% can create up to 40% fluctuations in optical power, when the output pulse stream is optically multiplexed. It is therefore desirable to lower the side lobe energy, i.e. maximize the extinction ratio of the optical pulses.

FIG. 2F illustrates the fluctuations caused by coherent interference of the output pulses 232, during optical time-division multiplexing. The fluctuations due to coherence interference are shown to be about 0.56 dB, for the configuration shown in FIG. 1A, in which only one of the pair of cascaded modulators is driven with a superposed, multi-frequency signal.

FIG. 3 illustrates a variable pulse width optical pulse generation system 300, constructed according to another embodiment of the present invention. The system 300 includes a pair of cascaded interferometric modulators 310 and 311. Both the first modulator and the second modulator are driven with single frequency drive signals 314, characterized by identical drive levels and bias conditions.

FIG. 4A illustrates the modulator transfer function 320 for the first and second interferometric modulators 310 and 311, for the system 300 illustrated in FIG. 3, as well as the RF drive signal 314 applied to both the first and the second modulator. The drive signal 314 is characterized by a single, 5 GHz sinusoidal frequency. For both modulators, the drive signal 314 is biased at a maximum optical transmission, and the peak-to-peak drive amplitude is about twice Vπ.

FIG. 4B illustrates the pulse carving functions from the first and the second modulators, for the system 300 illustrated in FIG. 3. The dotted curve 330 illustrates the first stage pulse carving function, i.e. illustrates a first modulated optical signal, generated by applying the modulation drive signal to the modulation input of the first modulator. The dashed curve 331 illustrates the second stage pulse carving function, i.e. the signal that would nominally result, if the second modulator were driven with the modulation drive signal 314, with a constant input optical power going into the optical input of the first modulator 310. The solid curve 332 illustrates the output optical pulses, resulting from a product of the dotted curve 330 with the dashed curve 331. The curve 332 represents the signal that results from modulating (with the drive signal 314) the time varying modulated output of the first interferometric modulator.

FIG. 4C illustrates the output optical pulse shape, and FIG. 4D illustrates the fluctuations due to OTDM coherent interference, for the output optical pulses generated by the system 300 driven with a single 5 GHz signal biased at the maximum optical transmission. The output pulses have a pulse width of about 24 ps, and the fluctuations due to coherent interference during OTDM are about 0.65 dB.

The pulse width can be narrowed by adjusting the relative amplitudes (hence the relative drive levels) of the single frequency drive signals applied to each modulator. FIG. 5 illustrates a cascaded interferometric modulator system 400 in which both modulators are driven with 5 GHz single frequency drive signals. The respective drive signals are biased at a maximum optical transmission, but are characterized by substantially different drive amplitudes.

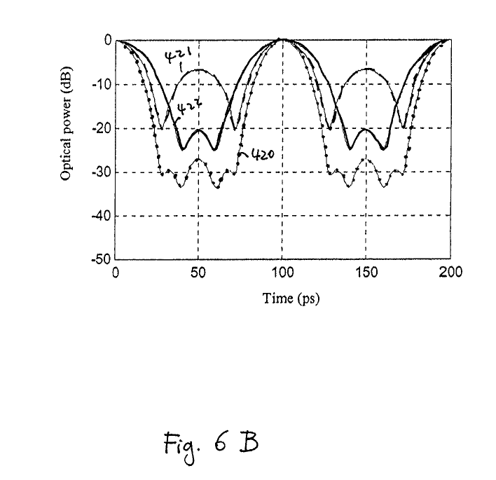

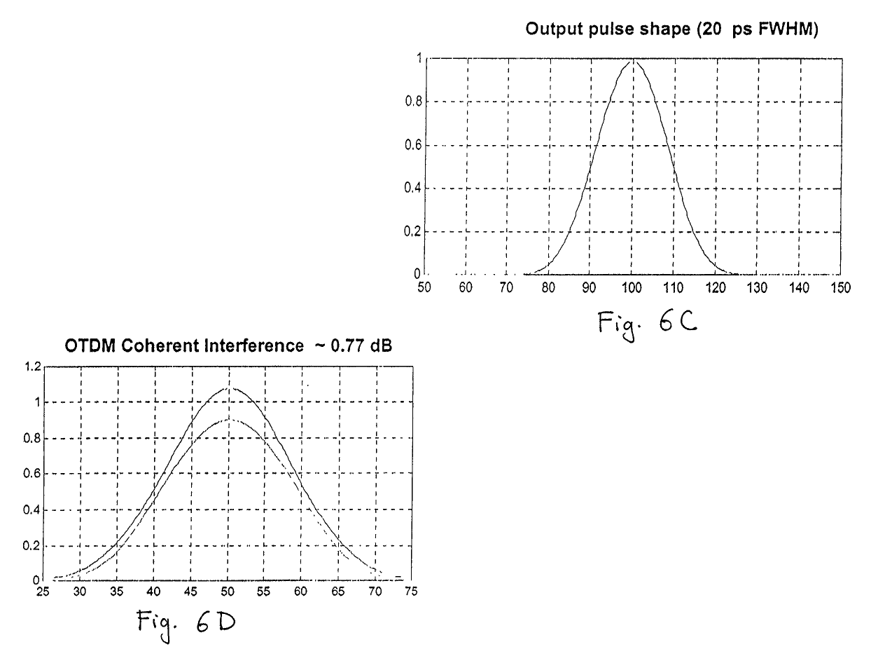

FIG. 6A illustrates the modulator transfer function 420 for both interferometric modulators for the system 400 illustrated in FIG. 5, as well as the RF drive signal applied to the first modulator. Both modulators are driven with single-frequency drive signals, at 5 GHz. In the illustrated embodiment, the drive amplitudes of the drive signals applied to each modulator are adjusted, in order to achieve output optical pulses having a narrower pulse width, as compared to the output optical pulses from the system 300 illustrated in FIG. 3. The drive amplitude for the drive signal applied to the first modulator is about 2.6 Vπ₁, whereas the drive amplitude for the drive signal applied to the second modulator is about 2.1 Vπ₂. As seen from FIG. 6A, the system 400 represents an “overdrive” configuration, in which the peak-to-peak amplitudes of the modulation drive signals are greater than twice Vπ.

The resulting pulse carving functions from the first and the second modulators are illustrated in FIG. 6B. The dashed curve 421 represents the first stage pulse carving function, i.e. the modulated optical signal generated from the output of the first modulator. The solid curve 422 represents the second stage pulse carving function, i.e. illustrates the modulated optical signal that would result from the output of the second modulator, assuming a constant input at the input of the second modulator. The dotted curve 420 results from a product of the dashed curve 421 with the solid curve 422, and illustrates the output optical pulses from the cascaded interferometric modulator system 400. The dotted curve 420 represents the modulated optical signal that results from applying the 5 GHz drive signal to the modulation input of the second modulator. The change in the shapes of the pulse carving functions, as compared to the pulse carving functions illustrated in FIG. 4B, results from the overdrive condition.

FIG. 6C illustrates the pulse shape of the output optical pulses from the optical pulse generation system 400 shown in FIG. 5. A pulse width of about 20 ps are achieved by using the bias and drive conditions of FIG. 5, i.e. by varying the relative amplitudes of the drive signals applied to the first and the second modulators until the ratio of the drive amplitudes is 2.6/2.1. A reduction in pulse width of about 20% is thereby achieved, as compared to the pulse width of about 24 ps achieved using the system illustrated in FIG. 3, in which the drive signals are characterized by identical drive amplitudes.

FIG. 6D illustrates the fluctuations due to OTDM coherent interference, for the optical pulses generated from the system illustrated in FIG. 5. As shown in FIG. 6D, the fluctuations due OTDM coherent interference are about 0.77 dB.

FIG. 7 illustrates another embodiment of the present invention, in which composite, multi-frequency signals are used to drive both modulators. In the illustrated embodiment, the relative amplitudes of the component signals are adjusted to values that substantially minimize the pulse width of the output optical pulses. In the variable pulse width optical pulse generation system 500 illustrated in FIG. 7, including a first modulator 501 and a second modulator 502, both the first and the second modulation drive signals are formed by superposing a 15 GHz signal onto a 5 GHz signal.

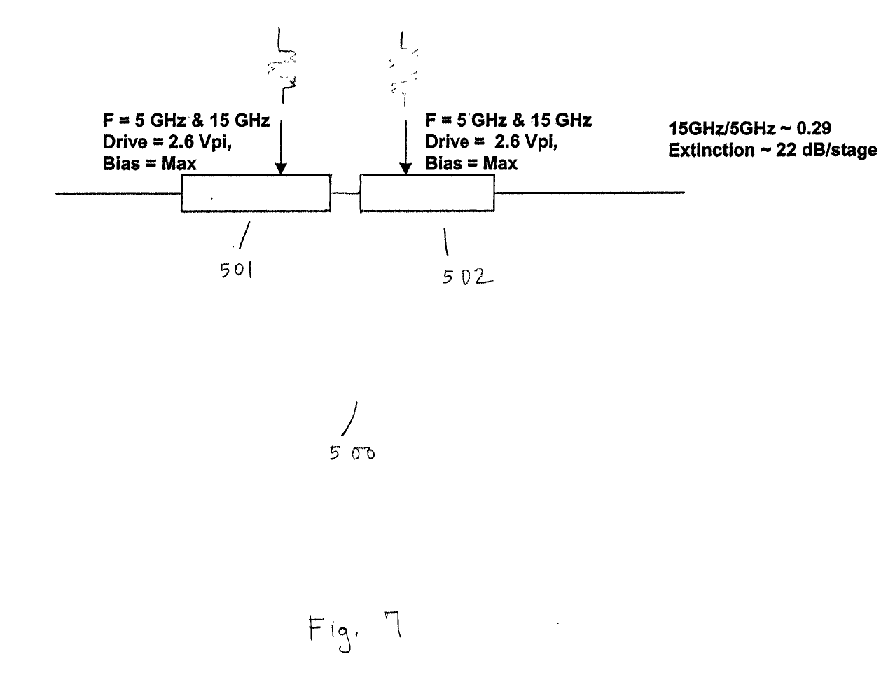

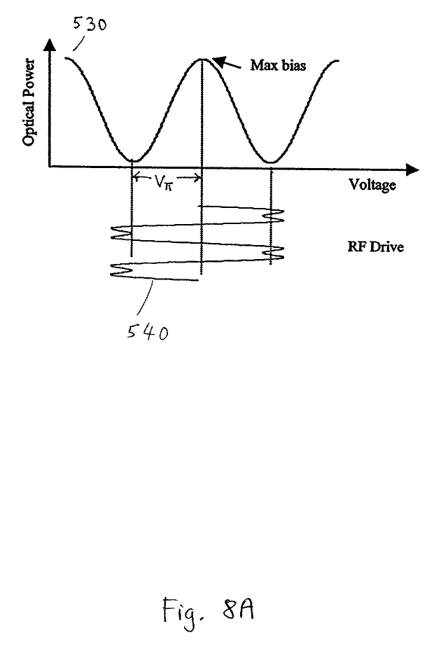

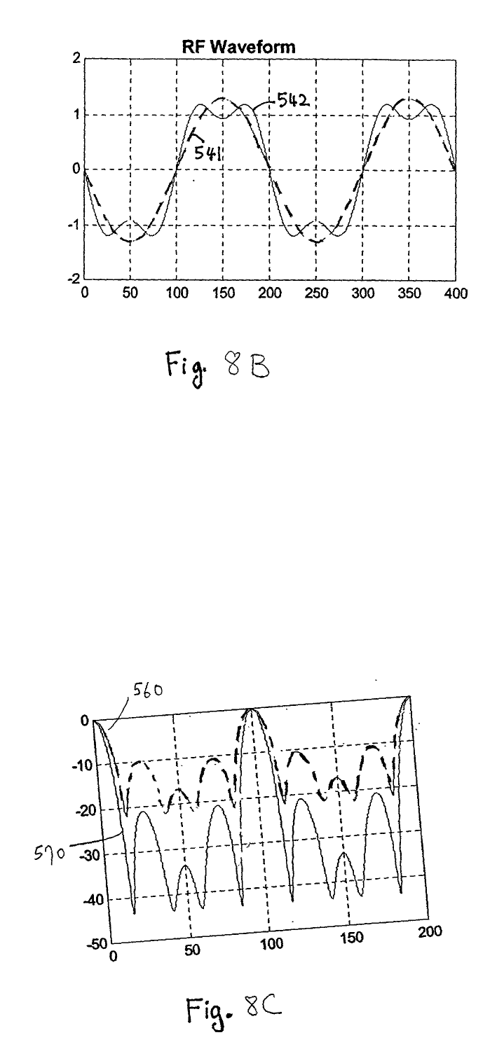

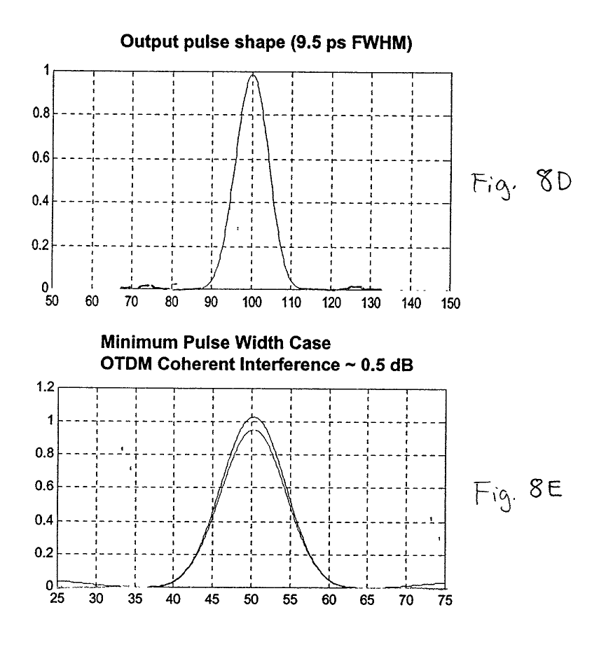

FIG. 8A illustrates the modulator transfer function 530 between the applied modulation signal and the output intensity for both the first 501 and the second 502 interferometric modulator in the system 500 illustrated in FIG. 4. Also shown is the drive signal 540 applied to the first and the second modulator. The same drive signal 540 is applied to both modulators in the system 500. The drive signal 540 is formed by superposing a 5 GHz sinusoidal waveform with a 15 GHz sinusoidal waveform. The drive amplitude of the 5 GHz component is about 2.6*Vπ. The relative amplitude of the 15 GHz waveform as compared to the amplitude of the 5 GHz waveform is chosen to be about 0.29. For both modulators, the drive signal 540 is biased at a maximum optical transmission.

FIG. 8B illustrates the RF waveform for the 5 GHz single frequency component of the modulation drive signal 540, as well as the RF waveform for the composite multi-frequency drive signal 540 applied to the first and the second modulators in the embodiment illustrated in FIG. 7. The dashed curve 541 illustrates a 5 GHz single frequency signal, whereas the solid curve 542 illustrates a composite signal resulting from mixing into the 5 GHz signal a 15 GHz component having a relative amplitude of about 0.15. Both stages are driven with the waveform represented by the solid curve 542.

FIG. 8C illustrates the pulse carving curves for the first and the second modulators, for the bias and drive conditions illustrated in FIG. 7. The dashed curve 560 illustrates a first modulated optical signal, generated by applying the modulation drive signal 540 to the modulation input of the first modulator 501. The dashed curve 560 represents the pulse carving curve for both the first and the second modulators, i.e. the dashed curve 560 also represents a second modulated optical signal that would result from driving the second modulator with the drive signal 540, assuming a constant input power at the input of the first modulator. The solid curve 570 provides the output optical pulse shape, i.e. illustrates a second modulated optical signal, which results from modulating the time varying modulated output 560 of the first interferometric modulator with the drive signal 540 to the modulation input of the second modulator 502 in the system 500.

FIG. 8D illustrates the pulse shape of the output optical pulses from the optical pulse generation system 500 shown in FIG. 7. By choosing a peak-to-peak drive amplitude for the 5 GHz component be about 2.6 Vπ, and by choosing the relative amplitude of the 15 GHz waveform to be about 0.29, the pulse width of the output optical pulses is substantially reduced, to about 9.5 ps.

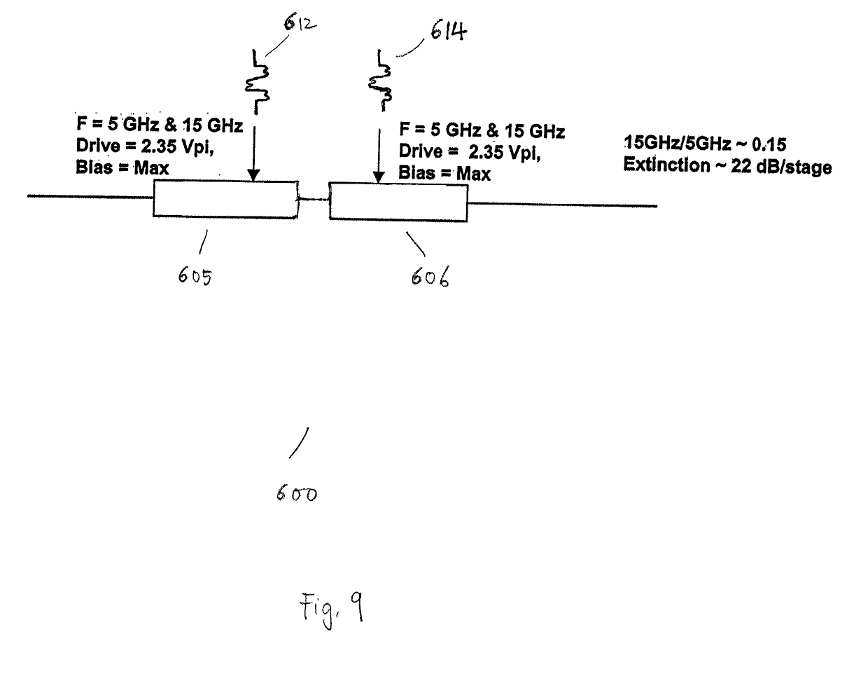

FIG. 8E illustrates the fluctuations resulting from OTDM coherent interference for the optical pulses generated by the optical pulse generation system 500 shown in FIG. 7. As seen in FIG. 9B, the fluctuations resulting from OTDM coherent interference are about 0.5 dB, when the amplitude of the first odd harmonic relative to the base waveform is chosen so as to minimize the pulse width of the output pulses.

By varying the relative amplitudes of the frequency components forming the multi-frequency drive signals, and by varying the drive amplitudes, pulse characteristics other than the output pulse width, for example fluctuations due to coherent interference of the pulses during optical time-division multiplexing, can be optimized. FIG. 9 illustrates a variable pulse width optical pulse generation system 600 constructed according to another embodiment of the present invention. The system 600 includes a first optical interferometric modulator 605, and a second interferometric modulator 606. In this embodiment, both modulators are driven with superposed multi-frequency drive signals 612 and 614. The relative amplitudes of the individual frequency components forming the drive signals, as well as the drive amplitudes of the drive signals, are chosen so as to minimize coherent interference during optical time division multiplexing.

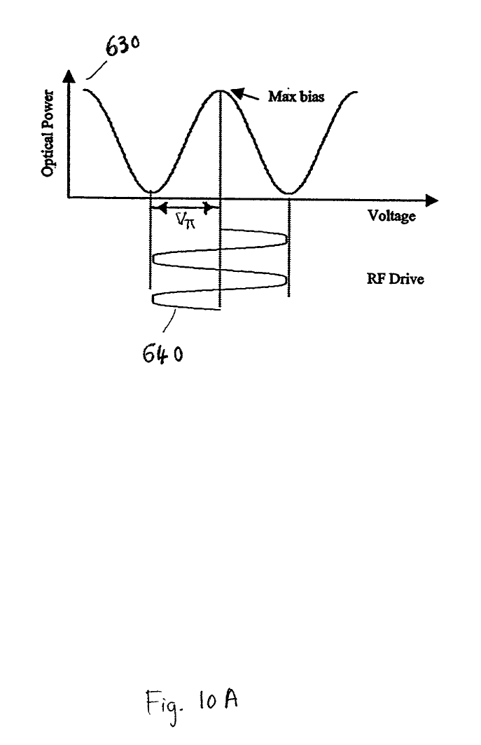

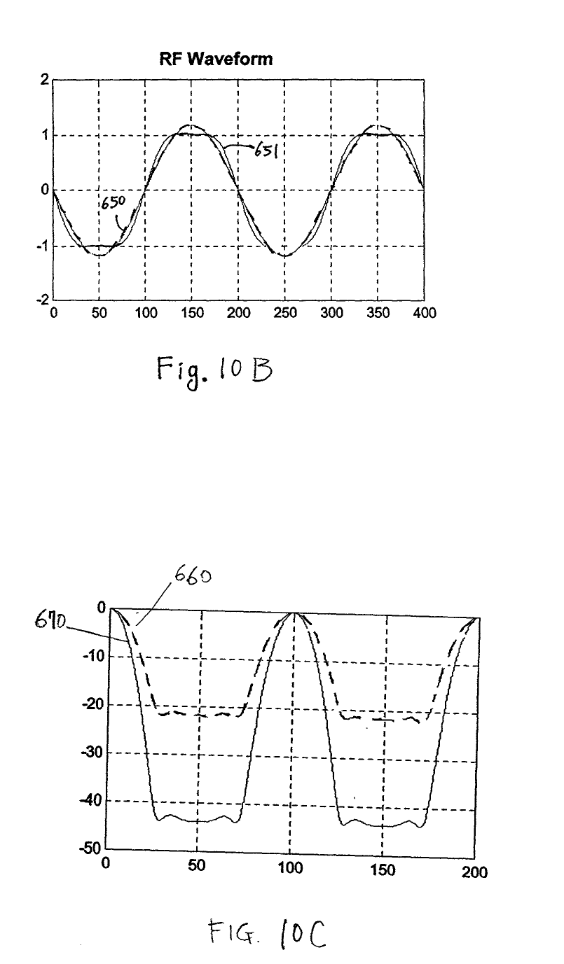

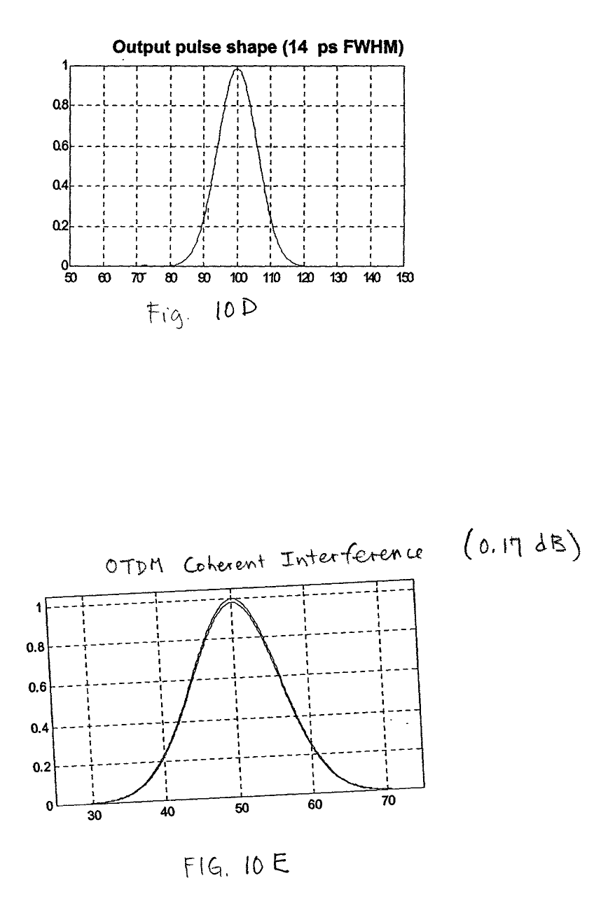

FIG. 10A illustrates the modulator transfer function 630 between the applied modulation signal and the output intensity for both the first and second interferometric modulators in the system illustrated in FIG. 9. Also shown is the drive signal 640 applied to the first and the second modulator. In the illustrated embodiment, the same drive signal 640 is applied to both modulators in the system 600. The drive signal 640 is formed by superposing a 5 GHz sinusoidal waveform with a 15 GHz sinusoidal waveform. The drive amplitude of the 5 GHz component of the drive signal 640 is about 2.35*Vπ. The relative amplitude of the 15 GHz waveform as compared to the amplitude of the 5 GHz waveform is chosen to be about 0.15. For both modulators, the drive signal 640 is biased at a maximum optical transmission.

FIG. 10B illustrates the RF waveform for the 5 GHz single frequency component of the modulation drive signal 640, as well as the RF waveform for the composite multi-frequency drive signal 640 applied to the first and the second modulators in the embodiment illustrated in FIG. 9. The dashed curve 650 illustrates a 5 GHz single frequency signal, whereas the solid curve 651 illustrates the composite signal resulting from mixing into the 5 GHz signal a 15 GHz signal having a relative amplitude of about 0.15.

FIG. 10C illustrates the pulse carving curves for the first and the second modulators, for the system 600 illustrated in FIG. 4. The dashed curve 660 represents the pulse carving curve for both the first and the second modulators. The dashed curve 660 represents a first modulated optical signal, generated by applying the modulation drive signal 640 to the modulation input of the first modulator 605, and also represents a second modulated optical signal that would result from driving the second modulator with the drive signal 540, assuming a constant input power at the input of the first modulator. The solid curve 670 illustrates the resulting output optical pulses from the cascaded modulator system 600. The solid curve represents a second modulated optical signal 670, which results from modulating with the drive signal 640 the time varying modulated output 660 of the first interferometric modulator.

FIG. 10D illustrates the pulse shape of the output optical pulses from the optical pulse generation system 600. The output optical pulses are characterized by a pulse width of about 14 ps. In this embodiment of the invention, the amount of residual side lobe power is significantly reduced. The extinction ratio is about 22 dB for each stage, in the embodiment illustrated in FIG. 9.

FIG. 10E illustrates the fluctuations due to OTDM coherent interference, for the optical pulses generated by the optical pulse generation system 600. When a 15 GHz frequency component is superposed onto a 5 GHz frequency component, to form a combined drive signal in which the relative amplitude of the 15 GHz frequency component is about 0.15, the OTDM coherent interference of the output optical pulses is substantially reduced, to about 0.17 dB. A 0.17 dB coherent interference translates to about 4% fluctuation in optical power. This represents a significant improvement, when compared to the prior art.

The embodiments discussed above relate to drive signal frequencies of 5 GHz, or a combined signal containing components at 5 GHz and at 15 GHz. It is understood, however, that other frequencies, or combinations of frequencies can be used in other embodiments of the invention. For example, drive signals at 10 GHz or 20 GHz can be used, and odd harmonics of these frequencies may be mixed in to achieve optimal pulse width and extinction ratio.

In summary, by varying the relative drive levels of the signals used to drive a cascaded set of optical interferometric modulators, and by driving the modulators with a combined signal containing a fundamental frequency and its odd harmonics, the present invention provides a system and method for generating variable pulse width RZ pulses whose characteristics can be optimized for a desired range of propagation conditions. In particular, it has been shown that the fluctuations due to coherent interference of the output optical pulses during optical time-division multiplexing can be substantially reduced, to about 0.17 dB, which represents a significant improvement over the prior art. It has also been shown that the pulse width of the output optical pulses can be reduced to about 9.5 ps, while maintaining the fluctuations from OTDM coherent interference to about 0.5 dB. The present invention provides the flexibility of further improving the output optical pulse characteristics by combining higher harmonics of a base frequency at selected relative amplitudes, although at present practical implementation is limited by the frequency limits in commercially available oscillators.

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. An optical pulse generation system, comprising:
A. a first optical interferometric modulator including:
i. an optical input for receiving an input optical signal,
ii. at least one modulation input for receiving a first modulation drive signal centered about a first normalized bias voltage V1, the first modulation drive signal modulating the input optical signal about the first normalized bias voltage with a first normalized amplitude Al; and
iii . an optical output for providing a first modulated optical signal; and
B. a second optical interferometric modulator including:
i. an optical input for receiving the first modulated optical signal;
ii. at least one modulation input for receiving a second modulation drive signal centered about a second normalized bias voltage V2, the second modulation drive signal modulating the first modulated optical signal about the second normalized bias voltage with a second normalized amplitude A2; and
iii. an optical output for providing a second modulated optical signal comprising output optical pulses;
wherein said first modulation drive signal and said second modulation drive signal are periodic functions of time; and wherein at least one of said first modulation drive signal and said second modulation drive signal comprises a superposition of a plurality of waveforms having different frequencies.

2. A system according to claim 1, wherein said superposition of waveforms comprises: i) a base waveform characterized by a base frequency ω₀, and ii) one or more odd harmonics of said base waveform, said odd harmonics being characterized by frequencies ωₙ related to said base frequency ω₀ according to the formula:
ωₙ=(2i+1)*ω₀
where n is a nonzero integer.

3. A system according to claim 1, wherein said base frequency ω₀ is from about 5 GHz to about 10 GHz.

4. A system according to claim 1,
wherein said first optical interferometric modulator is characterized by an optical output power-modulation voltage transfer function, and a parameter Vπ₁ that represents the voltage required to change the output power from the first modulator from a minimum value to a maximum value;
wherein said second optical interferometric modulator is characterized by an optical output power-modulation voltage transfer function, and a parameter Vπ₂ that represents the voltage required to change the output power from the second modulator from a minimum value to a maximum value;
wherein said first normalized bias voltage VI and said first normalized amplitude A1 are normalized relative to Vπ1; and
wherein said second normalized bias voltage V1 and said second normalized amplitude A2 are normalized relative to Vπ₂.

5. A system according to claim 1, wherein the relative amplitudes of said plurality of waveforms are selected so that the optical pulses in the second modulated signal have at least one of a predetermined extinction ratio and a predetermined pulse width.

6. A system according to claim 1, wherein at least one of the first and second normalized bias voltages and the first and second normalized amplitudes is selected so that the optical pulses in the second modulated signal have a predetermined extinction ratio.

7. A system according to claim 1, wherein at least one of the first and second normalized bias voltages and the first and second normalized amplitudes is selected so that the optical pulses in the second modulated signal have a predetermined pulse width.

8. A system according to claim 5, wherein said predetermined extinction ratio is between about 30 dB to about 50 dB.

9. A system according to claim 5, wherein said predetermined pulse width is between about 8 ps to about 16 ps.

10. A system according to claim 5,
wherein said predetermined pulse width is about 9.5 ps,
wherein said first and said second modulation drive signals each comprise a superposition of a first waveform having a frequency of about 5 GHz and an amplitude of about (2.6)*Vπ₁, and second waveform having a frequency of about 15 GHz, and wherein the ratio between the amplitude of the second waveform and the amplitude of the first waveform is about 0.29 in both drive signals; and
wherein said first bias voltage V1 biases the first modulator at a maximum optical transmission, and said second bias voltage V2 biases the second modulator at a maximum optical transmission.

11. A system according to claim 1, wherein the relative amplitudes of said plurality of waveforms are chosen so as to substantially reduce fluctuations in optical power due to coherent interference of the optical pulses in the second modulated optical signal, during optical time division multiplexing.

12. A system according to claim 11, wherein said fluctuations due to coherent interference are reduced to between about 0.1 dB to about 0.5 dB.

13. A system according to claim 11, wherein said fluctuations due to coherent interference are about 0.17 dB;
wherein said first and said second modulation drive signals each comprise a superposition of a first waveform having a frequency of about 5 GHz and an amplitude of about (2.35)*Vπ₁, and second waveform having a frequency of about 15 GHz, the ratio between the amplitude of the second waveform and the amplitude of the first waveform being about 0.15 in both drive signals; and
wherein said first bias voltage V1 biases the first modulator at a maximum optical transmission, and said second bias voltage V2 biases the second modulator at a maximum optical transmission.

14. A system according to claim 1, wherein at least one of the first and second interferometric modulators comprises a Mach-Zehnder modulator.

15. A system according to claim 1, further comprising:
a. means for generating said first modulation drive signal and for applying said first modulation drive signal to said at least one modulation input of said first interferometric modulator; and
b. means for generating said second modulation drive signal and for applying said second modulation drive signal to said at least one modulation input of said second interferometric modulator.

16. A system according to claim 1, further comprising bias means for biasing said first and said second modulation drive signals.

17. An optical pulse generation system, comprising:
A. a first optical interferometric modulator having:
i. an optical input for receiving an optical input signal,
ii. a modulation input for receiving a first modulation drive signal, and
iii. an optical output for providing a first modulated optical signal;
wherein said first optical interferometric modulator is characterized by an optical output power-modulation voltage transfer function, and a parameter Vπ₁, that represents the voltage required to change the output power from the first modulator from a minimum value to a maximum value;
wherein said transfer function of said first optical interferometric modulator is symmetrical about a center voltage between a lower drive voltage V₁₋ and an upper drive voltage V₁₊, and is substantially a single period sinusoid as a function of drive voltage between V₁₋ and V₁₊, having a maximum optical output power at the center voltage, and a minimum optical output power at V₁₋ and V₁₊;
B. a second optical interferometric modulator having:
i. an optical input for receiving the first modulated optical signal,
ii. a modulation input for receiving a second modulation drive signal, and
iii. an optical output that provides a second modulated optical signal comprising optical pulses;
wherein said second optical interferometric modulator is characterized by an optical output power-modulation voltage transfer function, and a parameter Vπ₂ that represents the voltage required to change the output power from the second modulator from a minimum value to a maximum value;
wherein said transfer function of said second optical interferometric modulator is symmetrical about a second center voltage between a lower drive voltage V₂₋ and an upper drive voltage V₂₊, and is substantially a single period sinusoid as a function of drive voltage between V₂₋ and V₂₊, having a maximum value at said second center voltage, and a minimum optical output power at V₁₋ and V₁₊;
C. a first modulator driver for applying said first modulation drive signal to said modulation input of said first modulator, wherein said first modulation drive signal is a periodic function of time having an amplitude A1 normalized to Vπ₁, and is centered about a first bias voltage V1=V₁₋+V_{1B}, wherein V_{1B} is a voltage magnitude normalized to Vπ₁; and
D. a second modulator driver for applying said second modulation drive signal to said modulation input of said second modulator,
wherein said second modulation drive signal is a periodic function of time having an amplitude A2 normalized to Vπ₂, and is centered about a second bias voltage V2=V_{2-=V}_{2B}, wherein V_{2B} is a voltage magnitude normalized to Vπ₂;
wherein at least one of the first and second modulation drive signals comprises a superposition of multi-frequency waveforms.

18. A system according to claim 17, wherein V_{1B} has a magnitude of about Vπ₁ so as to bias the first interferometric modulator substantially at a maximum optical transmission, and wherein V_{2B} has a magnitude of about Vπ₂ so as to bias the second interferometric modulator substantially at a maximum optical transmission.

19. A method of generating optical pulses, the method comprising:
A. generating a first modulated optical signal comprising optical pulses by applying a first modulation drive signal to a modulation input of a first optical interferometric modulator so as to modulate an input optical signal that has been received into an optical input of said first interferometric modulator, said first modulation drive signal being characterized by a first normalized bias voltage and a first normalized amplitude;
B. generating a second modulated optical signal comprising optical pulses by applying a second modulation drive signal to a modulation input of a second optical interferometric modulator so as to modulate the first modulated optical signal with a second modulation drive signal characterized by a second normalized bias voltage and a second normalized amplitude;
wherein the first modulation drive signal and the second modulation drive signal are periodic functions of time, and wherein at least one of the first modulation drive signal and the second modulation drive signal comprises a superposition of a plurality of waveforms having different frequencies.

20. A method according to claim 19, further comprising varying the relative amplitudes of said plurality of waveforms so as to substantially minimize coherent interference when the optical pulses in the second modulated optical signal are optically time-division-multiplexed.

21. A method according to claim 19, further comprising varying the relative amplitudes of said plurality of waveforms so as to substantially maximize the extinction ratio and substantially minimize the pulse width of the optical pulses in the second modulated optical signal.

22. A method according to claim 19, further comprising varying the relative amplitudes of said plurality of waveforms so as to achieve at least one of a predetermined extinction ratio and a predetermined pulse width of the optical pulses in the second modulated optical signal.

23. A method according to claim 22, wherein said predetermined extinction ratio is from about 30 dB to about 50 dB, and wherein said predetermined pulse width is from about 8 ps to about 16 ps.

24. A method according to claim 19, further comprising varying at least one of the first normalized amplitude and the second normalized amplitude to achieve optical pulses in the second modulated optical signal having a predetermined pulse width.

25. An optical pulse generation system, comprising:
A. a first optical interferometric modulator including:
i. an optical input for receiving an input optical signal,
ii. at least one modulation input for receiving a first modulation drive signal centered about a first normalized bias voltage V1, the first modulation drive signal modulating the input optical signal about the first normalized bias voltage with a first normalized amplitude A1; and
iii. an optical output for providing a first modulated optical signal; and
B. a second optical interferometric modulator including:
i. an optical input for receiving the first modulated optical signal;
ii. at least one modulation input for receiving a second modulation drive signal centered about a second normalized bias voltage V2, the second modulation drive signal modulating the first modulated optical signal about the second normalized bias voltage with a second normalized amplitude A2; and
iii. an optical output for providing a second modulated optical signal comprising output optical pulses;
wherein said first modulation drive signal and said second modulation drive signal are periodic functions of time characterized by a substantially identical frequency; and
wherein the ratio of the first normalized amplitude and the second normalized amplitude is adjusted so as to achieve a predetermined pulse width for the optical pulses in the second modulated signal.

26. A system according to claim 25, wherein the first normalized voltage is substantially equal to the second normalized voltage.
